(19) United States
(12) Patent Application Publication
(10) Pub. No.: US 2022/0206486 A1
(43) Pub. Date: Jun. 30, 2022

(54) METHOD AND SYSTEM FOR PREDICTIVE MAINTENANCE OF A MACHINERY ASSET

(71) Applicant: Infosys Limited, Bangalore (IN)

(72) Inventors: Sateesh Brhmadesam, Bangalore (IN); Sridhar Chidambaram, Bangalore (IN); Ravi Kumar Gvv, Bangalore (IN)

(21) Appl. No.: 17/554,207

(22) Filed: Dec. 17, 2021

(30) Foreign Application Priority Data
Dec. 31, 2020 (IN) 202041057378

(51) Int. Cl. G05B 23/02

(52) U.S. Cl. CPC G05B 23/0283

(57) ABSTRACT

A method and system for predictive maintenance of a machinery asset is provided. Data is collected from the sensors in the machine, and normalized for dealing with anomalies without removing them but passing onto the data transformation stage. Then the data is transformed and categorized based on multiple comparisons and calculations using the number of machine parts, and the operating values of the machine provided by the manufacturer. The categorized data is then used to predict the maintenance and recommended action for the machine part.

This application claims the benefit of Indian Patent Application No. 202041057378, filed Dec. 31, 2020, which is hereby incorporated by reference in its entirety.

### FIELD

This technology generally relates to method and system for predictive maintenance of a machinery asset, and more particularly, predictive maintenance using minimum event data.

### BACKGROUND

Predictive maintenance uses prognostics models for predicting errors or failures which needs huge data including the normal data and at least 3 to 5 events for a specific failure. The data presently used for predictive maintenance may have anomalies and missing data. The present prognostics models do not provide any option of handling the missing or erroneous data. There is no holistic approach for data transformation of the data before feeding to the predictive algorithm. The current technologies for predictive maintenance do not facilitate labelling of the data set, to help predict a failure.

Therefore, a process is needed to detect a specific event where we do not need as much data as the prognostic models require, and enable handling the raw dataset with its anomalies and without deleting any data.

### SUMMARY

A method for predictive maintenance of a machinery asset which comprises identifying a total number of parts of the machinery asset which impact an output of the machinery asset. When one failure event occurs, a data reading is extracted of the machinery asset. The extracted data is normalized by updating one or more discrepant values in the extracted data reading using Bayes rule. Using the data, updating one or more threshold value provided by a manufacturer of the machinery asset based on the identified number of parts of the machinery asset, transforming the normalized data reading by comparing with the updated one or more threshold values, using one or more substitute values, wherein the substitute values is calculated based on the identified number of parts of machinery asset, calculating a number of performance categories for the machinery asset using the number of the identified one or more parts of the machinery asset, a total number of working state of the machinery asset, and a possible number of working state of the machinery asset at one time. Performing a predefined calculation on the transformed normalized data for the one or more parts of the machinery asset which effect an output of the machinery asset, and categorizing into at least one of the calculated performance categories; and recommending an appropriate maintenance for the identified one or more parts of the machinery asset based on the categorized performance categories.

A system for predictive maintenance of a machinery asset, comprising an identifier for identifying a total number of parts of the machinery asset which impact an output of the machinery asset, one or more sensors for extracting a data reading for one failure event of the machinery asset using a data processor configured to perform, normalizing the extracted data reading by updating one or more discrepant values in the extracted data reading using Bayes rule, updating one or more threshold value provided by a manufacturer of the machinery asset based on the identified number of parts of the machinery asset, transforming the normalized data reading by comparing with the updated one or more threshold values, using one or more substitute values, wherein the substitute values is calculated based on the identified number of parts of machinery asset, calculating a number of performance categories for the machinery asset using, the number of the identified one or more parts of the machinery asset, a total number of working state of the machinery asset; and a possible number of working state of the machinery asset at one time; performing a predefined calculation on the transformed normalized data for the one or more parts of the machinery asset which effect an output of the machinery asset, and categorizing into at least one of the calculated performance categories; and an event predictor (304) for recommending an appropriate maintenance for the identified one or more parts of the machinery asset based on the categorized performance categories.

A non-transitory computer readable medium for performing predictive maintenance of a machinery asset which comprises identifying a total number of parts of the machinery asset which impact an output of the machinery asset. When one failure event occurs, a data reading is extracted of the machinery asset. The extracted data is normalized by updating one or more discrepant values in the extracted data reading using Bayes rule. Using the data, updating one or more threshold value provided by a manufacturer of the machinery asset based on the identified number of parts of the machinery asset, transforming the normalized data reading by comparing with the updated one or more threshold values, using one or more substitute values, wherein the substitute values is calculated based on the identified number of parts of machinery asset, calculating a number of performance categories for the machinery asset using the number of the identified one or more parts of the machinery asset, a total number of working state of the machinery asset, and a possible number of working state of the machinery asset at one time. Performing a predefined calculation on the transformed normalized data for the one or more parts of the machinery asset which effect an output of the machinery asset, and categorizing into at least one of the calculated performance categories; and recommending an appropriate maintenance for the identified one or more parts of the machinery asset based on the categorized performance categories.

This technology provides several advantages including not deleting even a single record from the data readings. It provides predictive maintenance even where there is less data to develop and implement the maintenance process.

### BRIEF DESCRIPTION OF THE DRAWINGS

FIG. 1 is an exemplary network environment which comprises a predictive maintenance device;

FIG. 2 is a flowchart of an exemplary method for predictive maintenance of a machinery asset;

FIG. 3 is an exemplary architecture of implementing the method for predictive maintenance of a machinery asset; and

FIG. 4 is an illustration of exemplary data set.

### DETAILED DESCRIPTION

Disclosed embodiments provide computer-implemented methods, systems, and computer-readable media for predictive maintenance of a machinery asset. A user refers to at least one user who is using the predictive maintenance system. Machinery asset refers to any engineering machine, or one or more part of any machine. It can also be a system of connected machines. For the purpose of this document, machinery asset has been referred only as a machinery.

While the particular embodiments described herein may illustrate the disclosure in a particular domain, the broad principles behind these embodiments could be applied in other fields of endeavor. To facilitate a clear understanding of the present disclosure, illustrative examples are provided herein which describe certain aspects of the disclosure. However, it is to be appreciated that these illustrations are not meant to limit the scope of the disclosure, and are provided herein to illustrate certain concepts associated with the disclosure.

It is also to be understood that the present disclosure may be implemented in various forms of hardware, software, firmware, special purpose processors, or a combination thereof. Preferably, the present disclosure is implemented in software as a program tangibly embodied on a program storage device. The program may be uploaded to, and executed by, a machine comprising any suitable architecture.

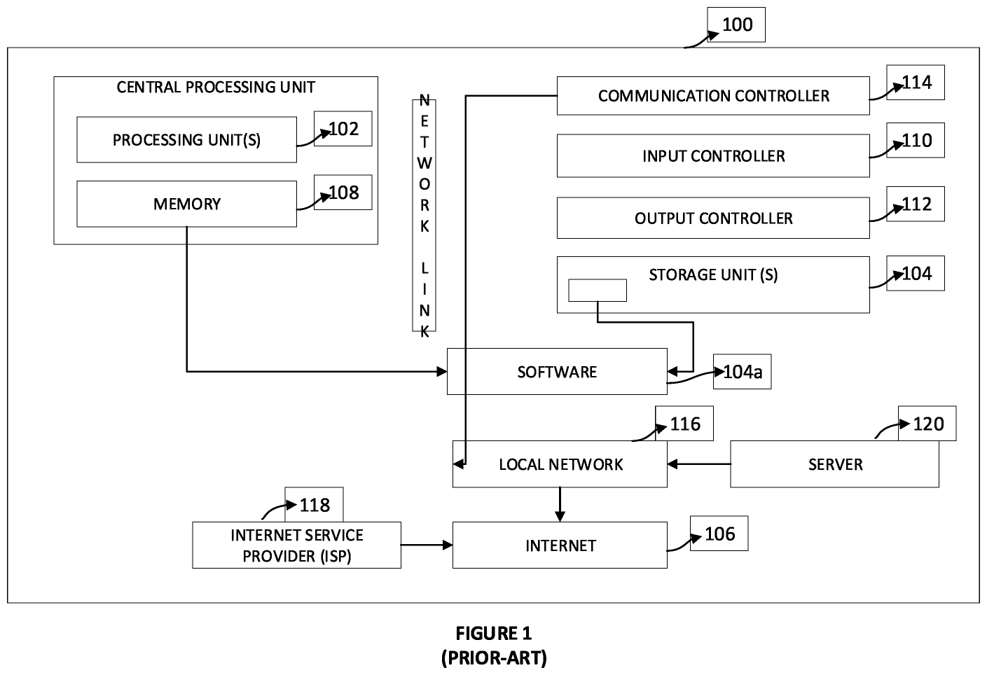

FIG. 1 is a block diagram of a computing device 100 to which the present disclosure may be applied according to an embodiment of the present disclosure. The computing machine may be configured for performing the process of predictive maintenance of a machine as explained herewith. The computing device and the machine may connected together by the Local Area Network (LAN) and Wide Area Network (WAN) including other types and numbers of devices, components, elements and communication networks in other topologies and deployments. While not shown, additional components, such as routers, switches and other devices which are well known to those of ordinary skill in the art may also be used and thus will not be described here. This technology provides several advantages including providing more effective methods, non-transitory computer readable medium and devices for predictive maintenance. The system includes at least one processor 102, designed to process instructions, for example computer readable instructions (i.e., code) stored on a storage device 104. By processing instructions, processing device 102 may perform the steps and functions disclosed herein. Storage device 104 may be any type of storage device, for example, but not limited to an optical storage device, a magnetic storage device, a solid-state storage device and a non-transitory storage device. The storage device 104 may contain software 104a which is a set of instructions (i.e. code). Alternatively, instructions may be stored in one or more remote storage devices, for example storage devices accessed over a network or the internet 106. The computing device also includes an operating system and microinstruction code. The various processes and functions described herein may either be part of the microinstruction code or part of the program (or combination thereof) which is executed via the operating system. Computing device 100 additionally may have memory 108, an input controller 110, and an output controller 112 and communication controller 114. A bus (not shown) may operatively couple components of computing device 100, including processor 102, memory 108, storage device 104, input controller 110 output controller 112, and any other devices (e.g., network controllers, sound controllers, etc.). Output controller 110 may be operatively coupled (e.g., via a wired or wireless connection) to a display device (e.g., a monitor, television, mobile device screen, touch-display, etc.) in such a fashion that output controller 110 can transform the display on display device (e.g., in response to modules executed). Input controller 108 may be operatively coupled (e.g., via a wired or wireless connection) to input device (e.g., mouse, keyboard, touch-pad, scroll-ball, touch-display, etc.) in such a fashion that input can be received from a user. The communication controller 114 is coupled to a bus (not shown) and provides a two-way coupling through a network link to the internet 106 that is connected to a local network 116 and operated by an internet service provider (hereinafter referred to as ‘ISP’) 118 which provides data communication services to the internet. Network link typically provides data communication through one or more networks to other data devices. For example, network link may provide a connection through local network 116 to a host computer, to data equipment operated by an ISP 118. A server 120 may transmit a requested code for an application through internet 106, ISP 118, local network 116 and communication controller 114. Of course, FIG. 1 illustrates computing device 100 with all components as separate devices for ease of identification only. Each of the components may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 100 may be one or more servers, for example a farm of networked servers, a clustered server environment, or a cloud network of computing devices.

Although an exemplary computing environment is described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

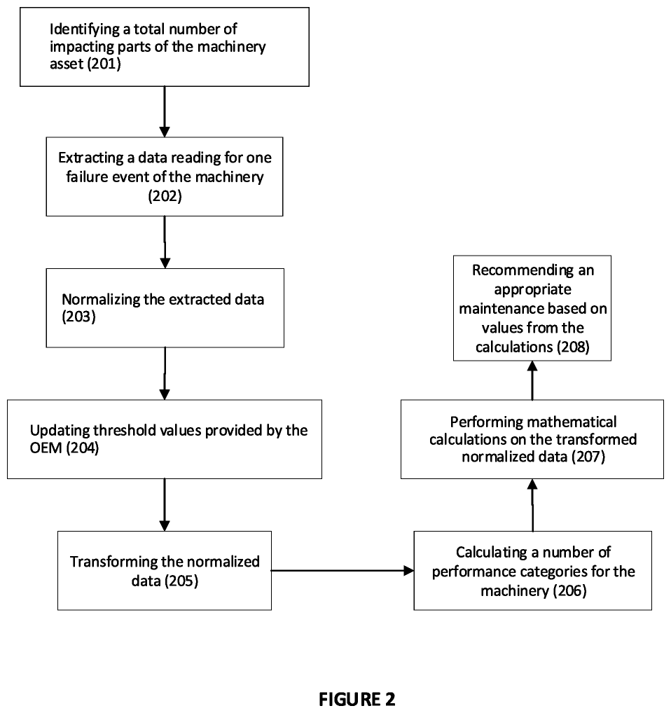

An exemplary method for Predictive Maintenance of a Machinery Asset will now be described with reference to FIG. 2.

In an embodiment, a machinery may have some parts which impact it's working. Some parts may have a direct impact on the performance of the machinery, and some parts may have an indirect impact on the performance. In one embodiment, a user can decide the percentage of impact which can be defined as a direct impact. In an example if the correlation factor is equal to greater than 98%, then the impact maybe called direct impact, and if the correlation factor is greater than 70% and less than 80%, then the impact maybe called indirect impact. The machine parts which are involved/directly responsible for the degradation of a specific machine part or have a direct impact, have been addressed as Primary variables for the specific machine in this disclosure. The machine parts, which are indirectly involved in the degradation of the machine or have an indirect impact, or which aid/help/act as catalyst for the degradation of the machine, have been addressed as secondary variables in this disclosure. For the purpose of this document, we can address machine parts, which have a direct impact, as primary variables. And the machine parts which may indirectly impact the performance are addressed as secondary variables.

In an embodiment, all the primary variables of the machinery are identified (201). Every machinery can have multiple parts which directly impact the performance of the machinery. In the event the machinery asset or any portion of the machinery asset faces a failure, the primary variables are mainly the cause of it. In an embodiment if no primary variables can be identified, a user may continue the process considering secondary variables.

The present disclosure can provide predictive maintenance with only one event data. Therefore in an embodiment, when only one failure event has occurred, data is collected from the one or more sensors in the machine (202). This helps avoid the use of huge amounts of data to perform the maintenance of any machine, or its part. This also helps in quick processing and faster turnaround. The data set collected from the sensors of the machine relate to the one or more parts of the machine. The user may collect data from the sensors relating to the primary variables. The data set may comprise reading of the sensors during various time period of the day when the failure event occurred. The data set may also be collected for different time periods, as needed by the user.

In an embodiment the data set collected from sensors may have many anomalies. This may occur due to error while reading the data, or data transfer, or while data recording, or any other power or other related logistic issues. In one embodiment of the present disclosure, the data set is normalized to take care of these anomalies (203). As a part of data normalization, any negative reading in the collected data set may be converted to zero or an appropriate value as suggested by domain expert. Further, normalization may also include checking the missing values in the data set. In an embodiment the missing value may be imputed using Bayes rule of probability. This probability maybe based on bringing the previous values based on context of that specific machine part and putting in the place of the missing value. This helps identify the best possible value and the most appropriate value in place of the missing values.

In one embodiment, the data set may have Not Applicable or NA reading. In these cases, the sensors may have been unable to provide a reading or may have faced an error. During data normalization, these values maybe converted to Null in an embodiment. The appropriate values may then be imputed.

In one embodiment, along with data normalization, the operating values provided by the machine manufacturer, for machine parts whose data has been collected, are also processed (204). These operating values are reconfigured to identify thresholds for the most ideal operating ranges, and gradually the lesser ideal operating ranges and also the least ideal operating ranges. The reconfiguration may be done based on the number of primary variables identified in the machine. The number of thresholds to be configured from the operating values provided by the manufacturer maybe calculated by,

(Number of primary variables)+1

Therefore in an example where the number of primary variables are 3, then the number of thresholds will be 3+1 i.e. 4. Accordingly the thresholds may be ‘lower working limit’, ‘stabilized working limit’, ‘normal working limit’ and ‘upper working limit’.

In another example if the number of primary variables are 4, then the number of thresholds will be 4+1, i.e. 5. Therefore the thresholds may be 1st lower threshold, 2nd lower threshold, normal working range, 1st higher threshold and 2nd higher threshold. Accordingly can appropriately decide the thresholds to be configured.

In an embodiment, the thresholds that are configured based on the number of primary variables are user configurable. A user may decide the operating ranges or the thresholds based on the type of machine or the maintenance that is required. A user may configure more operating ranges at the lower threshold, depending on the type of machine.

The normalized data may then be transformed (205) for feeding into the prediction process. An appropriate number of substitute values are used for the purpose of data transformation. The number of substitute value maybe calculated based on number of primary variables. In one embodiment, the number of substitute value to be used is calculated as,

Number of primary variables+c,

where c is a constant denoting the number of working states the machine can be in, at a time.
In an embodiment, the value of c maybe 1 i.e. at a time the machine can be in one operating state. The operating states can be working, not working, standby and other operating states as per the machine.
Therefore in case when the number of primary variables is 2, the threshold values will be

2+1=3, and the number of substitute values will be 2+1=3.

In one embodiment, the substitute values to be used for data transformation start from 0. In the present example where primary variables are 2, therefore number of substitute values will be 3. Hence the substitute values starting from zero will be, 0, 1 and 2.
In case where number of substitute value comes out to be 5, the values starting from zero maybe 0, 1, 2, 3, 4.

These substitute values maybe used for data transformation of the normalized data.

In an embodiment, for the purpose of data transformation (205), the normalized data set, the substitute values and the reconfigured operating values maybe considered. The normalized data set is compared with the reconfigured operating values and based on that the values of the data set are replaced with the substitute values. If a data reading falls between the first two operating values, the data reading is replaced with 0. If a data reading falls between next two operating values it is replaced with 1, and so on. As per the calculation explained above, the number of substitute values used above and the number of operating values will be same. Hence all data can be transformed within the operating ranges.

In an example, if the substitute values are three, i.e. 0, 1 and 2; and operating values are also 3 i.e. zero to lower operating value; lower to normal operating value; and normal to upper operating values—the data can be transformed as per below rules—
i. If a data reading is between zero to lower operating value, it will be replaced with 0;
ii. If a data reading is between lower operating range to normal operating range, it will be replaced with 1; and
iii. If a data reading is between normal operating range to upper operating range it will be replaced with 2.

The above explained data transformation is user configurable, and can be done in a different way as more suited to a user, while maintaining the core objective of the transformation.

In an embodiment, the number of pattern classes are calculated (206). Pattern classes may denote categories of performance of the machine. It may also be defined as type of failures which can happen for a machine. The number of pattern classes may be calculated by—

x\hat{ }n+c, where

x=number of primary variables;
n=total number of working states of the machine; and
c=constant representing the number of operating state of the machine at one time.
We may consider n=2 i.e. working and non-working state; and
c=1, i.e. either working on non-working at a time.
If we consider primary variables as 2, the number of pattern classes will be
2\hat{ }2+1=5.

Once the pattern classes are calculated, the transformed data is labelled and categorized into pattern classes (207). For labelling, a predecided mathematical calculation is performed on the transformed data. A user can select the mathematical calculation from the below—

### Addition,

### Subtraction,

### Multiplication,

### Division; and

### Mod %

In an example, if a user selects addition, all the data values for one machine part is added, from the transformed data set. In an embodiment, the data reading comprises reading of various parts of the machine during different times of the day, including when a failure event has occurred. A mathematical calculation selected by the user is performed on all the data reading of each machine part, from the transformed data set.

In an embodiment, the calculated answer for each machine part maybe the pattern class labelling for that machine part. In an example where the substitute values used for data transformation are 0, 1, 2, the primary variables are 2, and the mathematical calculation used is addition, the number of pattern classes would be 5, and the value of pattern class would be

0+0=0;
0+1=1;
0+2=2;
1+2=3;
2+2=4;
i.e. 5 pattern classes, which is also 2\hat{ }2+1.

Finally based on the pattern classes, appropriate action maybe recommended for the machine part. These maybe preconfigured recommended actions. A user may configure recommended action for various pattern classes. It is applicable for all machines, which have their own respective degradations over a period of operation. An example of recommended action relating to performance degradation/scaling issues in a HVAC machine, based on above pattern classes maybe—
‘0’ would be marked to a reading if the given values sum of the data reading of the machine is 0. This pattern class may indicate the presence of domain outlier values of the given machine part. Domain outlier values may indicate that the machine or the part is operating below its normal operating/working range or the machine or the part is switched OFF. The below normal operating values maybe called Lower Threshold Domain Outlier values.
‘1’ would be marked to a reading if the given values sum of the data reading of the machine is 1. It may mean normal working condition for that reading/observation/record. It may indicate the machine or the part is in the normal operating/working range. In another embodiment it may indicate the machine or the part is switched ON. These values which are within the normal operating range maybe called Normal Operating values. It may mean these values are above Lower threshold and Less than Higher Threshold values range of the operating ranges provided by manufacturer.

‘2’ would be marked to a reading if the given values sum of the data reading of the machine is 2. It may mean normal working condition for Optimal Level Degradation issue, which may be, interpreted as no threat as of now. It may indicates the machine or the part is switched ON and in the normal operating/working range where the degradation levels are very less. So, these values maybe in the Optimum Level degradation.
‘3’ would be marked to a reading if the given values sum of the data reading of the machine is 3. In one example, it may be interpreted as degradation condition has become serious and needs attention for repair/maintenance/brushing activity to be conducted. One part of the machine maybe is normal and another maybe breaching higher threshold value. These values maybe called Higher threshold domain Outliers.
‘4’ would be marked to a reading if the given values sum of the data reading of the machine is 4. It may means scaling condition has become very serious and needs attention for repair/maintenance/brushing activity to be conducted. Both values breach higher threshold values. The machine parts may have breached higher threshold level. In addition, it may indicate there is inadequate output levels. On the other hand, it may be both degradation/scaling and inadequate output. These values maybe called Higher threshold domain Outliers.

Accordingly, the recommended actions may vary as per the user and the machine requirements. In one embodiment, once transformed data set is available as explained in above paragraphs, it may be provided to a decision tree classification process. The decision tree classification algorithm may classify and provides the pattern value as already described and based on pattern value classified, the value maybe interpreted and appropriate action is recommended. The result of the decision tree may be provided for alerts or notifications based on pattern class knowledge interpretation and get the predictions for the machine or the parts.

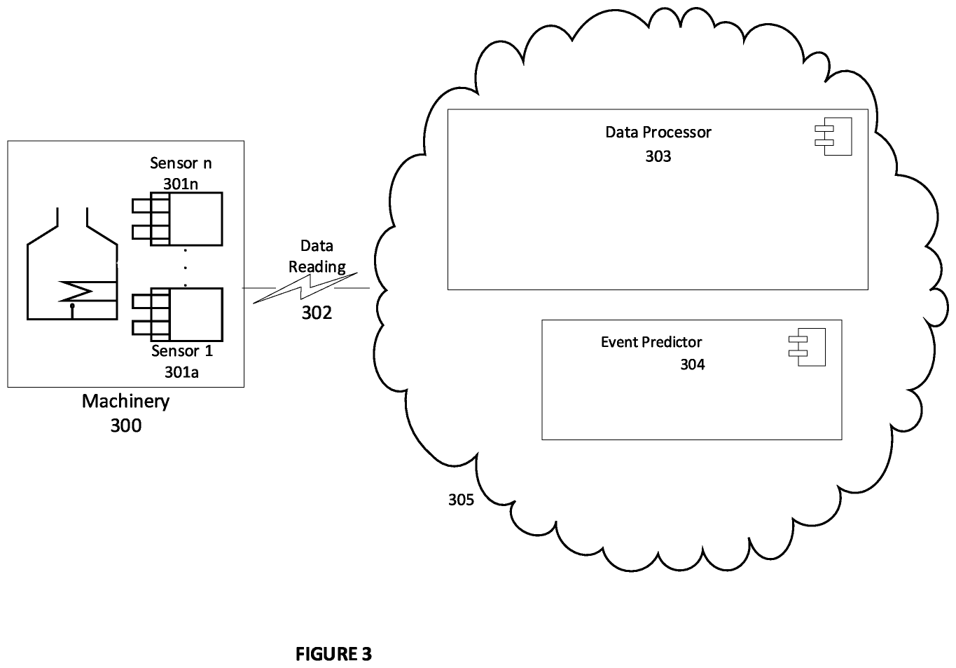

An exemplary architecture of implementing the method for predictive maintenance of a machine will now be described along with the description of FIG. 3. In an embodiment, machine (300) may represent any manufacturing or engineering machine with many sub components, parts, sensors and other interrelating components. The sensors may be used to detect data readings of the various parts of the machine (300). In one embodiment, the machine may have one or more sensors (301a . . . 301n). The number of sensors may depend type of machine, or the number of sub components of the machine or any other parameter.

In the event once the machine faces a single failure event, data maybe collected from the sensors, relating to the parts of the machine. This data maybe transferred to a server (305), or a remote user machine for further processing. In one embodiment data maybe uploaded to cloud for further processing. The data maybe transferred to a processing component through any known data communication means including wired or wireless network elements (302). Along with data readings the user may also transfer the other related data. The related data may include the number of primary variables that directly impact the performance of the machine, the working states of the machine, and the possible working states of the machine at one time. In another embodiment some or all of the related data may be available at the server machine. This also includes the operating values of the machine provided by the manufacturer.

In one embodiment, the data is transferred to a server. The server machine may have data preprocessing as well as processing components (303). The data preprocessing component may be configured to normalize the data. This may include correcting the anomalies such as negative data, missing data and any other incorrect data or invalid data. It may further also reconfigure the operating values provided by the manufacturer, for the machine.

In one embodiment the data processing component may then transform the data values by comparing them with the reconfigured operating values of the machine. The data processing component may further be configured to calculate the pattern classes. In another embodiment this may be provided along with the data readings and the related values along with other data.

In an embodiment the data processing component may be configured to label the data readings. These are then transferred to the event predictor (304). The event predictor may be configured to identify the preventive action of the machine parts based on the labeled data readings. Decision tree. The decision tree classification algorithm may classify and provide the pattern value and based on pattern value classified, the value maybe interpreted and appropriate action is recommended.

In an embodiment, the output by the event predictor may be passed back to the machine to perform the recommended action.

The implementation as described above maybe performed in any other architecture. It may be implemented at the same location as the machine, or at a remote location, and using any configurable computing environment.

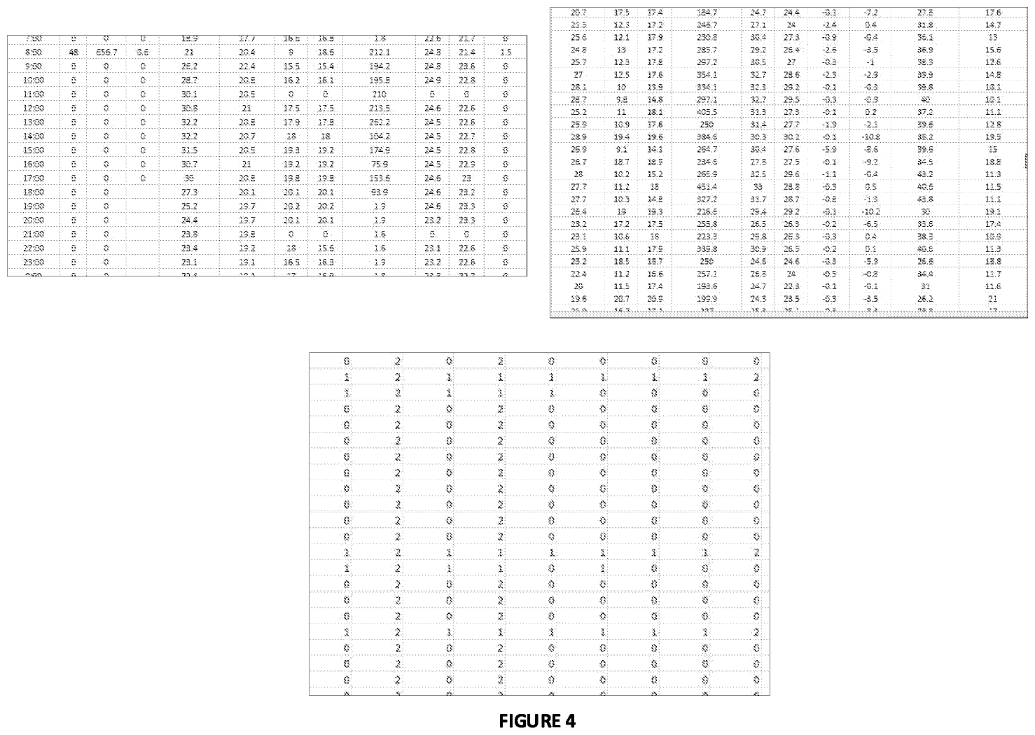

An illustration of exemplary data set is described along with description of FIG. 4. Two exemplary initial data reading sets are depicted in the figure for the purpose of explanations. The initial two data sets show some values as zero, and some missing data readings. The data set also shows negative values for some data readings. Thus an extracted data set may have multiple type of anomalies in the data. The present disclosure may normalize the data and deal and correct all such anomalies and impute the correct value using Bayes rule.

The figure also depicts an exemplary transformed data set. The transformed data includes the calculated substitute values. The figure shows the use of 0, and 1 substitute values. This transformed data is then labelled and categorized as explained in the above paragraphs. Appropriate maintenance action maybe recommended based on the labelling.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for predictive maintenance of a machinery asset, the method comprising:
identifying, by a computing device, a total number of parts of the machinery asset which impact an output of the machinery asset;
extracting, by the computing device, a data reading for one failure event of the machinery asset;
normalizing, by the computing device, the extracted data reading by updating one or more discrepant values in the extracted data reading using Bayes rule;
updating, by the computing device, one or more threshold value provided by a manufacturer of the machinery asset based on the identified number of parts of the machinery asset;
transforming, by the computing device, the normalized data reading by comparing with the updated one or more threshold values, using one or more substitute values, wherein the substitute values is calculated based on the identified number of parts of machinery asset;
calculating, by the computing device, a number of performance categories for the machinery asset using:
the number of the identified one or more parts of the machinery asset;
a total number of working state of the machinery asset; and
a possible number of working state of the machinery asset at one time;
performing, by the computing device, a predefined calculation on the transformed normalized data for the one or more parts of the machinery asset which effect an output of the machinery asset, and categorizing into at least one of the calculated performance categories; and
recommending, by the computing device, an appropriate maintenance for the identified one or more parts of the machinery asset based on the categorized performance categories.

2. The method as claimed in claim 1, wherein the normalizing the extracted data comprises:
converting negative values in the extracted data reading to a preconfigured value; and
imputing missing values in the extracted data set, using Bayes rule.

3. The method as claimed in claim 2, wherein the normalizing further comprises, converting, by the computing device, a not applicable data reading to null; and
imputing, by the computing device, a data value for the null reading.

4. The method as claimed in claim 1, wherein the updating further comprises configuring, by the computing device, the one or more threshold value provided by a manufacturer as per the identified total number of parts of the machinery asset.

5. The method as claimed in claim 4, wherein the transforming comprises:
comparing, by the computing device, the normalized data with the configured one or more threshold values; and
substituting, by the computing device, the normalized data with the calculated substitute values, based on the comparison.

6. The method as claimed in claim 1, wherein the calculating comprises: performing, by the computing device:
Xⁿ+c, where
x is the identified number of parts of the machinery asset;
n is total number of working states of the machinery asset; and
c is a constant referring to a number of working states of the machinery asset at one time.

7. The method as claimed in claim 5, wherein the predefined calculation is performed on the transformed data for labelling the transformed data into one of the calculated pattern classes.

8. The method as claimed in claim 7, further comprising providing, by the computing device, one or more prediction for the machine parts based on the calculated pattern class labels.

9. A system for predictive maintenance of a machinery asset, comprising:
an identifier for identifying a total number of parts of the machinery asset which impact an output of the machinery asset;
one or more sensors for extracting a data reading for one failure event of the machinery asset using;
a data processor configured to perform,
normalizing the extracted data reading by updating one or more discrepant values in the extracted data reading using Bayes rule;
updating one or more threshold value provided by a manufacturer of the machinery asset based on the identified number of parts of the machinery asset;
transforming the normalized data reading by comparing with the updated one or more threshold values, using one or more substitute values, wherein the substitute values is calculated based on the identified number of parts of machinery asset;
calculating a number of performance categories for the machinery asset using:
the number of the identified one or more parts of the machinery asset;
a total number of working state of the machinery asset; and
a possible number of working state of the machinery asset at one time;
performing a predefined calculation on the transformed normalized data for the one or more parts of the machinery asset which effect an output of the machinery asset, and categorizing into at least one of the calculated performance categories; and
an event predictor that recommends an appropriate maintenance for the identified one or more parts of the machinery asset based on the categorized performance categories.

10. The system as claimed in claim 9, wherein the data processor is configured for the normalizing the extracted data to further comprise:
converting negative values in the extracted data reading to a preconfigured value; and
imputing missing values in the extracted data set, using Bayes rule.

11. The system as claimed in claim 10, wherein the data processor is configured for the normalizing the extracted data to further comprise:
converting not applicable data reading to null; and
imputing a data value for the null reading.

12. The system as claimed in claim 9, wherein the data processor is further configured for the updating to configure the one or more threshold value provided by a manufacturer as per the identified total number of parts of the machinery asset.

13. The system as claimed in claim 12, wherein the data processor is configured for the transforming to further comprise:
comparing the normalized data with the configured one or more threshold values; and
substituting the normalized data with the calculated substitute values, based on the comparison

14. The system as claimed in claim 9, wherein the data processor is configured for the calculating to further comprise:
Xⁿ+c, where
x is the identified number of parts of the machinery asset;
n is total number of working states of the machinery asset; and
c is a constant referring to a number of working states of the machinery asset at one time.

15. The system as claimed in claim 13, wherein the predefined calculation is performed on the transformed data for labelling the transformed data into one of the calculated pattern classes.

16. The system as claimed in claim 15, further comprising providing one or more prediction for the machine parts based on the calculated pattern class labels.

17. A non-transitory computer readable medium for predictive maintenance of a machinery asset, with instructions stored thereon that, when executed by a processor, cause the processor to perform operations comprising,
identifying a total number of parts of the machinery asset which impact an output of the machinery asset;
extracting a data reading for one failure event of the machinery asset;
normalizing the extracted data reading by updating one or more discrepant values in the extracted data reading using Bayes rule;
updating one or more threshold value provided by a manufacturer of the machinery asset based on the identified number of parts of the machinery asset;
transforming the normalized data reading by comparing with the updated one or more threshold values, using one or more substitute values, wherein the substitute values is calculated based on the identified number of parts of machinery asset;
calculating a number of performance categories for the machinery asset using:
the number of the identified one or more parts of the machinery asset;
a total number of working state of the machinery asset; and
a possible number of working state of the machinery asset at one time;
performing a predefined calculation on the transformed normalized data for the one or more parts of the machinery asset which effect an output of the machinery asset, and categorizing into at least one of the calculated performance categories; and
recommending an appropriate maintenance for the identified one or more parts of the machinery asset based on the categorized performance categories.
